(19) United States
(12) Patent Application Publication
(10) Pub. No.: US 2016/0004299 A1
(43) Pub. Date: Jan. 7, 2016

(54) SYSTEMS AND METHODS FOR ASSESSING, VERIFYING AND ADJUSTING THE AFFECTIVE STATE OF A USER

(71) Applicant: Intelligent Digital Avatars, Inc., Mequon, WI (US)

(72) Inventors: Thomas W. Meyer, Berkeley, CA (US); Mark Stephen Meadows, Emeryville, CA (US); Navroz Jehangir Daroga, Mequon, WI (US)

(21) Appl. No.: 14/791,419

(22) Filed: Jul. 4, 2015

Related U.S. Application Data
(60) Provisional application No. 62/021,069, filed on Jul. 4, 2014.

(51) Int. Cl. G06F 3/01; G06F 9/44; G06F 3/0484

(52) U.S. Cl. CPC G06F 3/011; G06F 3/0484; G06F 9/4446

(57) ABSTRACT

Aspects of the present disclosure are directed to systems, devices and methods for assessing, verifying and adjusting the affective state of a user. An electronic communication is received in a computer terminal from a user. The communication may be a verbal, visual and/or biometric communication. The electronic communication may be assigned at least weighted descriptive value and a weighted time value which are used to calculate a current affective state of the user. Optionally, the computer terminal may be triggered to interact with the user to verify the current affective state if the current affective state is ambiguous. The optional interaction may continue until the current affective state is achieved. Next, the computer terminal may be triggered to interact with the user to adjust the current affective state upon a determination that the current affective state is outside an acceptable range from a pre-defined affective state.

### CLAIM OF PRIORITY UNDER 35 U.S.C. §119

The present application for patent claims priority to U.S. Provisional Application No. 62/021,069 entitled “SYSTEMS AND METHODS FOR GENERATING AUTOMATED EMOTIONAL MODELS AND INTERACTIONS OF EMPATHETIC FEEDBACK”, filed Jul. 4, 2014, and hereby expressly incorporated by reference herein.

### FIELD

The present application relates to systems and methods for assessing, verifying and adjusting the affective state of a user.

### BACKGROUND

Applications executed by computing devices are often used to control virtual characters. Such computer-controlled characters may be used, for example, in training programs, or video games, or in educational programs, or in personal assistance. These applications that control virtual characters may operate independently or may be embedded in many devices, such as desktops, laptops, wearable computers, and in computers embedded into vehicles, buildings, robotic systems, and other places, devices, and objects. Many separate characters may also be included in the same software program or system of networked computers such that they share and divide different tasks and parts of the computer application. These computer-controlled characters are often deployed with the intent to carry out dialogue and engage in conversation with users, also known as human conversants, or the computer-controlled characters may be deployed with the intent to carry out dialogue with other computer-controlled characters. This interface to information that uses natural language, in English and other languages, represents a broad range of applications that have demonstrated significant growth in application, use, and demand.

Interaction with computer-controlled characters has been limited in sophistication, in part due to the inability of computer-controlled characters to both recognize and convey non-textual forms of communication missing in natural language, and specifically textual natural language. Many of these non-textual forms of communication that people use when speaking to one another, commonly called “body language,” or “tone of voice” or “expression” convey a measurably large set of information. In some cases, such as sign language, all the data of the dialogue may be contained in biometric measurements.

Elements of communication that are both textual (Semantic) and non-textual (Biometric) may be measured by computer-controlled software. First, in terms of textual information, the quantitative analysis of semantic data yields a great deal of data and information about intent, personality, era, context and may be used to evaluate both written and spoken language. Bodies of text are often long and contain only limited amount of sentences that contain sentiment and affect. This makes it difficult to make an informed decision based on the content. Second, in terms of biometric information, or non-textual information, biometrics, polygraphs, and other methods of collecting biometric information such as, heart rate, facial expression, tone of voice, posture, gesture, and so on have been in use for a long time. These biometrics have also traditionally been measured by computer-controlled software and as with textual analysis, there is a degree of unreliability due to differences between people's methods of communication, reaction, and other factors. Semantic and biometric data are two different fields of analysis that have traditionally each lacked strong conclusive data. Using only one of these two methods leads to unreliable results that can create uncertainty in business decisions, costing great deals of time and money however combining them offers methods of improving both accuracy and reliability.

Now that it is possible to establish a method of evaluating a conversant's emotion, it is therefore possible for the system to establish a means of emulating that emotion, of generating artificial emotion, and of engaging in emotional interactions. These emotional interactions may be generated such that large-scale sets of consistent emotional interactions may be defined, including belief, trust, mistrust, and highly passionate states like hatred, love, and others.

Trust relationships with, and confidence in, conversational systems and computer-controlled characters, specifically those that are designed to integrate with finances, health, medicine, personal assistance, and matters of business are important. Users of computer-controlled characters must have a level of emotional confidence to make decisions related to such important topics. Many computer-controlled characters today lack the ability to build and manage that emotional relationship resulting in a great lack of functionality for Sellers and online vendors including insurance companies, healthcare companies, and others. The resulting loss of business for companies is large, as is the lack of services, goods, and information for consumers.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts or examples of one or more implementations in a simplified form as a prelude to the more detailed description that is presented later.

Various aspects of the disclosure provide for a computer implemented method for assessing, verifying and adjusting an affective state of users comprising executing on a processing circuit the steps of: receiving an electronic communication in a computer terminal with a memory module and an affective objects module, the electronic communication is selected from at least one of a verbal communication, a visual communication and a biometric communication from a user; assigning the electronic communication at least one first weighted descriptive value and a first weighted time value and storing the least one first weighted descriptive value and the first weighted time value in a first memory location of the memory module; calculating with the processing circuit a current affective state of the user based on the at least one first weighted descriptive value and the first weighted time value and storing the current affective state in a second memory location of the memory module; and triggering the computer terminal to interact with the user to adjust the current affective state of the user upon a determination that the current affective state of the user is outside an acceptable range from a pre-defined affective state.

According to one feature, the affective objects module in the computer terminal may comprise a parsing module, a biometrics module, a voice interface module and a visual interface module.

According to another feature, an interaction with the user is selected from at least one of verbal interaction and a visual interaction.

According to yet another feature, the method may further comprise executing on the processor the step of triggering the computer terminal to interact with the user to verify the current affective state of the user upon determining the current affective state is ambiguous until verification of the current affective state is achieved.

According to yet another feature, the current affective state is an emotion; and wherein the current affective state of the user is ambiguous when the emotion is uncertain. The emotion can be selected from at least two possible emotions.

According to yet another feature, the method may further comprise executing on the processor the steps of receiving a second electronic communication in the computer terminal from the user; assigning the second electronic communication at least one second weighted descriptive value and a second weighted time value and storing the least at one second weighted descriptive value and the second weighted time value in a third memory location of the memory module; and calculating with the processing circuit an updated current affective state of the user based on the at least one second weighted descriptive value and the first weighted time value and storing the current affective state in a fourth memory location of the memory module.

According to yet another feature, the method may further comprise executing on the processor the steps of triggering the computer terminal to interact with the user to verify the updated current affective state of the user upon determining the updated current affective state is ambiguous until verification of the updated current affective state is achieved; and triggering the computer terminal to interact with the user to adjust the updated current affective state of the user upon a determination that the updated current affective state of the user is outside the acceptable range from the pre-defined affective state.

According to yet another feature, the method may further comprise executing on the processor the step of triggering a direct interaction with the user by an individual upon a determination by the processing circuit that the updated current affect state has remained ambiguous for a pre-determined length of time.

According to yet another feature, the pre-defined affective state is selected from an affective state database; wherein the affective state database is dynamically built from prior interactions between the computer terminal and previous users; and wherein the affective state of the user is updated on a pre-determined periodic time schedule.

According to another aspect, for dynamically assessing, verifying and adjusting an affective state of users is provided. The mobile device includes a processing circuit; a communications interface communicatively coupled to the processing circuit for transmitting and receiving information; an affective objects module communicatively coupled to the processing circuit; and a memory module communicatively coupled to the processing circuit for storing information. The processing circuit is configured to receive an electronic communication in the mobile device, the electronic communication is selected from at least one of a verbal communication, a visual communication and a biometric communication from a user; assign the electronic communication at least one first weighted descriptive value and a first weighted time value and storing the least one first weighted descriptive value and the first weighted time value in a first memory location of the memory module; calculate with the processing circuit a current affective state of the user based on the at least one first weighted descriptive value and the first weighted time value and storing the current affective state in a second memory location of the memory module; and trigger the mobile device to interact with the user to adjust the current affective state of the user upon a determination that the current affective state of the user is outside an acceptable range from the pre-defined affective state.

According to one feature, the affective objects module in the mobile device comprises a parsing module, a biometrics module, a voice interface module and a visual interface module.

According to another feature, an interaction with the user is selected from at least one of verbal interaction and a visual interaction.

According to yet another feature, the processing circuit is further configured to trigger the mobile device to interact with the user to verify the current affective state of the user upon determining the current affective state is ambiguous until verification of the current affective state is achieved.

According to yet another feature, the current affective state is an emotion; wherein the current affective state of the user is ambiguous when the emotion is uncertain; and wherein device of claim 14, wherein the emotion can be selected from at least two possible emotions.

According to yet another feature, the processing circuit is further configured to receive a second electronic communication in the mobile device from the user; assign the second electronic communication at least one second weighted descriptive value and a second weighted time value and storing the least at one second weighted descriptive value and the second weighted time value in a third memory location of the memory module; and calculate with the processing circuit an updated current affective state of the user based on the at least one second weighted descriptive value and the first weighted time value and storing the current affective state in a fourth memory location of the memory module.

According to yet another feature, the processing circuit is further configured to trigger the mobile device to interact with the user to verify the updated current affective state of the user upon determining the updated current affective state is ambiguous until verification of the updated current affective state is achieved; and trigger the computer terminal to interact with the user to adjust the updated current affective state of the user upon a determination that the updated current affective state of the user is outside the acceptable range from the pre-defined affective state.

According to yet another feature, the processing circuit is further configured to trigger a direct interaction with the user by an individual upon a determination by the processing circuit that the updated current affect state has remained ambiguous for a pre-determined length of time.

According to yet another feature, the pre-defined affective state is selected from an affective state database; and wherein the affective state database is dynamically built from prior interactions between the computer terminal and previous users.

According to yet another feature, the affective state of the user is updated on a pre-determined periodic time schedule.

### BRIEF DESCRIPTION OF THE DRAWINGS

FIG. 1 illustrates an example of a networked computing platform utilized in accordance with an exemplary embodiment.

FIG. 2 is a flow chart illustrating a method of assessing the semantic mood of an individual, in accordance with an exemplary embodiment.

FIGS. 3A and 3B is a flow chart illustrating of a method of assessing the biometric mood in the form one or more potential imprecise characteristics of an individual, in accordance with an aspect of the present disclosure.

FIG. 4 is a flow chart of a method of extracting semantic and biometric data from conversant input, in accordance with an aspect of the present disclosure.

FIG. 5 is a flow chart illustrating of an overview of achieving defined emotional goals or an affective state between a software program and a user, or between two software programs, according to one example.

FIG. 6 illustrates a graph utilized to determine a system's position relative to a conversant.

FIG. 7 illustrates a method utilized by a system to determine its position (or distance) relative to the conversant.

FIGS. 8A, 8B and 8C illustrate a method utilized by a system to determine and achieve emotional goals set forth in the computer program prior to initiation of a dialogue.

FIGS. 9A and 9B illustrate a method utilized by a system to assess, verify and adjust the affective state of a user, according to one aspect.

FIG. 10 is a diagram illustrating an example of a hardware implementation for a system configured to assess, verify and adjust the affective state of a user.

FIG. 11 is a diagram illustrating an example of the modules/circuits or sub-modules/sub-circuits of the affective objects module or circuit of FIG. 10.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, the term “embodiments” does not require that all embodiments include the discussed feature, advantage or mode of operation.

The term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other.

### Overview

Aspects of the present disclosure are directed to systems, devices and methods for assessing, verifying and adjusting the affective state of a user. An electronic communication is received in a computer terminal from a user. The communication may be a verbal, visual and/or biometric communication. The electronic communication may be assigned at least weighted descriptive value and a weighted time value which are used to calculate a current affective state of the user. Optionally, the computer terminal may be triggered to interact with the user to verify the current affective state if the current affective state is ambiguous. The optional interaction may continue until the current affective state is achieved. Next, the computer terminal may be triggered to interact with the user to adjust the current affective state upon a determination that the current affective state is outside an acceptable range from a pre-defined affective state.

The affective state of the user may continually be updated based on a pre-determined time schedule or whenever it appears the affective state no longer accurately depicts the user. When updating the affective state, another electronic communication may be received in the computer terminal from the user. This additional electronic communication may be assigned at least one weighted descriptive value and a weighted time value both of which are used to calculate an updated current affective state of the user. Optionally, the computer terminal may be triggered to interact with the user to verify the updated current affective state if the current affective state is ambiguous. The optional interaction may continue until the updated current affective state is achieved. Next, the computer terminal may be triggered to interact with the user to adjust the updated current affective state upon a determination that the updated current affective state is outside an acceptable range from a pre-defined affective state. The computer terminal may also be triggered to have an individual have a direct interaction if a determination is made by the processing circuit that the updated current affect state has remained ambiguous for a pre-determined length of time.

### Networked Computing Platform

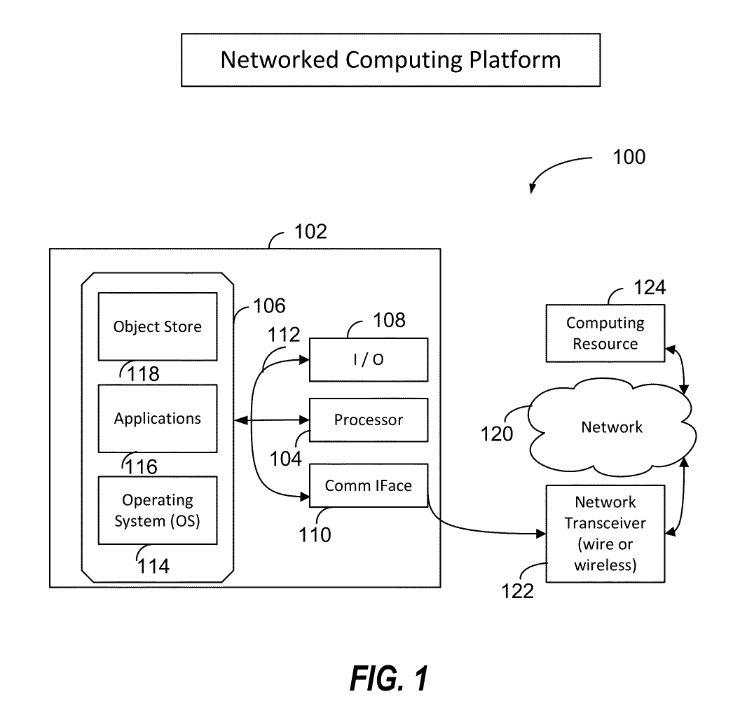

FIG. 1 illustrates an example of a networked computing platform utilized in accordance with an exemplary embodiment. The networked computing platform 100 may be a general mobile computing environment that includes a mobile computing device and a medium, readable by the mobile computing device and comprising executable instructions that are executable by the mobile computing device. As shown, the networked computing platform 100 may include, for example, a mobile computing device 102. The mobile computing device 102 may include a processing circuit 104 (e.g., processor, processing module, etc.), memory 106, input/output (I/O) components 108, and a communication interface 110 for communicating with remote computers or other mobile devices. In one embodiment, the afore-mentioned components are coupled for communication with one another over a suitable bus 112.

The memory 106 may be implemented as non-volatile electronic memory such as random access memory (RAM) with a battery back-up module (not shown) such that information stored in memory 106 is not lost when the general power to mobile device 102 is shut down. A portion of memory 106 may be allocated as addressable memory for program execution, while another portion of memory 106 may be used for storage. The memory 106 may include an operating system 114, application programs 116 as well as an object store 118. During operation, the operating system 114 is illustratively executed by the processing circuit 104 from the memory 106. The operating system 114 may be designed for any device, including but not limited to mobile devices, having a microphone or camera, and implements database features that can be utilized by the application programs 116 through a set of exposed application programming interfaces and methods. The objects in the object store 118 may be maintained by the application programs 116 and the operating system 114, at least partially in response to calls to the exposed application programming interfaces and methods.

The communication interface 110 represents numerous devices and technologies that allow the mobile device 102 to send and receive information. The devices may include wired and wireless modems, satellite receivers and broadcast tuners, for example. The mobile device 102 can also be directly connected to a computer to exchange data therewith. In such cases, the communication interface 110 can be an infrared transceiver or a serial or parallel communication connection, all of which are capable of transmitting streaming information.

The input/output components 108 may include a variety of input devices including, but not limited to, a touch-sensitive screen, buttons, rollers, cameras and a microphone as well as a variety of output devices including an audio generator, a vibrating device, and a display. Additionally, other input/output devices may be attached to or found with mobile device 102.

The networked computing platform 100 may also include a network 120. The mobile computing device 102 is illustratively in wireless communication with the network 120—which may for example be the Internet, or some scale of area network—by sending and receiving electromagnetic signals of a suitable protocol between the communication interface 110 and a network transceiver 122. The network transceiver 122 in turn provides access via the network 120 to a wide array of additional computing resources 124. The mobile computing device 102 is enabled to make use of executable instructions stored on the media of the memory 106, such as executable instructions that enable computing device 102 to perform steps such as combining language representations associated with states of a virtual world with language representations associated with the knowledgebase of a computer-controlled system, in response to an input from a user, to dynamically generate dialog elements from the combined language representations.

### Semantic Mood Assessment

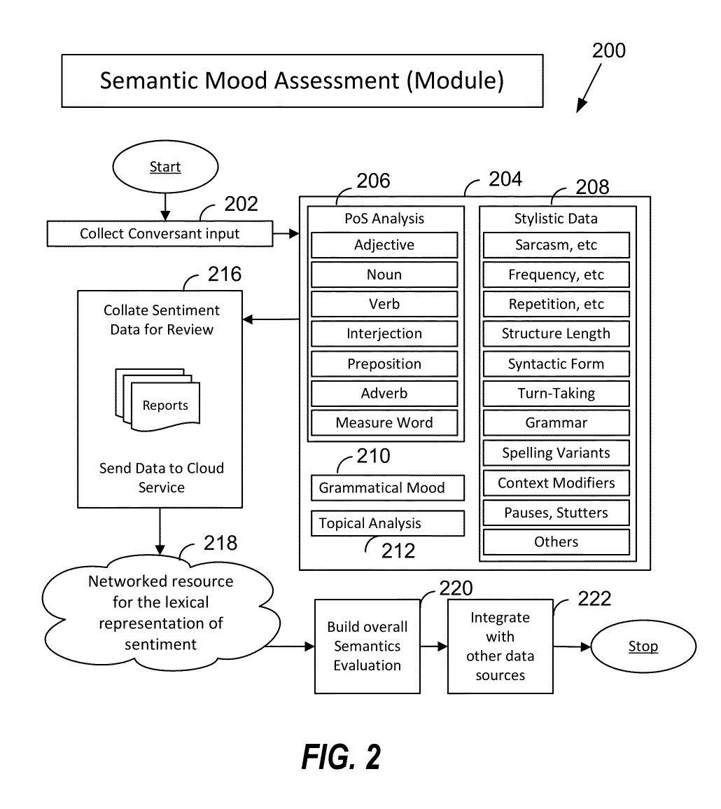

FIG. 2 is a flow chart illustrating a method of assessing the semantic mood of an individual by obtaining or collecting one or more potential imprecise characteristics, in accordance with an aspect of the present disclosure. First, conversant input from a user (or individual) may be collected 202. The conversant input may be in the form of audio, visual or textual data generated via text, gesture, and/or spoken language provided by users.

According to one example, the conversant input may be spoken by an individual speaking into a microphone. The spoken conversant input may be recorded and saved. The saved recording may be sent to a voice-to-text module which transmits a transcript of the recording. Alternatively, the input may be scanned into a terminal or may be a graphic user interface (GUI).

Next, a semantic module may segment and parse the conversant input for semantic analysis 204 to obtain one or more potentially imprecise characteristics. That is, the transcript of the conversant input may then be passed to a natural language processing module which parses the language and identifies the intent (or potential imprecise characteristics) of the text. The semantic analysis may include Part-of-Speech (PoS) Analysis 206, stylistic data analysis 208, grammatical mood analysis 210 and topical analysis 212.

In PoS Analysis 206, the parsed conversant input is analyzed to determine the part or type of speech in which it corresponds to and a PoS analysis report is generated. For example, the parsed conversant input may be an adjective, noun, verb, interjections, preposition, adverb or a measured word. In stylistic data analysis 208, the parsed conversant input is analyzed to determine pragmatic issues, such as slang, sarcasm, frequency, repetition, structure length, syntactic form, turn-taking, grammar, spelling variants, context modifiers, pauses, stutters, grouping of proper nouns, estimation of affect, etc. A stylistic analysis data report may be generated from the analysis. In grammatical mood analysis 210, the grammatical mood of the parsed conversant input may be determined (i.e. potential imprecise characteristics). Grammatical moods can include, but are not limited to, interrogative, declarative, imperative, emphatic and conditional. A grammatical mood report is generated from the analysis. In topical analysis 212, a topic of conversation is evaluated to build context and relational understanding so that, for example, individual components, such as words may be better identified (e.g., the word “star” may mean a heavenly body or a celebrity, and the topic analysis helps to determine this). A topical analysis report is generated from the analysis.

Once the parsed conversant input has been analyzed, all the reports relating to sentiment data of the conversant input are collated 216. As described above, these reports may include, but are not limited to a PoS report, a stylistic data report, grammatical mood report and topical analysis report. The collated reports may be stored in the Cloud or any other storage location.

Next, from the generated reports, the vocabulary or lexical representation of the sentiment of the conversant input may be evaluated 218. The lexical representation of the sentiment of the conversant input may be a network object that evaluates all the words identified (i.e. from the segmentation and parsing) from the conversant input, and references those words to a likely emotional value that is then associated with sentiment, affect, and other representations of mood. Emotional values, also known as weighted descriptive values, are assigned for creating a best guess or estimate as to the individual's (or conversant's) true emotional state. According to one example, the potential characteristic or emotion may be “anger” and a first weighted descriptive value may be assigned to identify the strength of the emotion (i.e. the level of perceived anger of the individual) and a second weighted descriptive value may be assigned to identify the confidence that the emotion is “anger”. The first weighted descriptive value may be assigned a number from 0-3 (or any other numerical range) and the second weighted descriptive value may be assigned a number from 0-5 (or any other numerical range). These weighted descriptive values may be stored in a database of a memory module located on a handset or a server.

According to one feature, the weighted descriptive values may be ranked in order of priority. That is, one weighted descriptive value may more accurately depict the emotions of the individual. The ranking may be based on a pre-defined set of rules located on the handset and/or a server. For example, the characteristic of anger may be more indicative of the emotion of a user than a characteristic relating to the background environment in which the individual is located. As such, the characteristic of anger may outweigh characteristics relating to the background environment.

Each potential imprecise characteristic identified from the data may also be assigned a weighted time value corresponding to a synchronization timestamp embedded in the collected data. Assigning a weighted time value may allow for time-varying streams of data, from which the potential imprecise characteristics are identified, to be accurately analyzed. That is, potential imprecise characteristics identified within a specific time frame are analyzed to determine the one or more precise characteristics. This accuracy may allow for emotional swings, which typically take several seconds to manifest, in emotion from an individual to be captured.

According to one example, for any given emotion, such as “anger”, the probability of it reflecting the individual's (or conversant's) actual emotion (i.e. strength of the emotion) may be approximated using the following formula:

P(i)=w₀*t₀(t)*c₀+ . . . wᵢ*tᵢ(t)*cᵢ+ . . . wₚ*P(i−1)

Where w is a weighting factor, t is a time-based weighting (recent measurements are more relevant than measurements made several second ago), and c is the actual output from the algorithm assigning the weighted descriptive values. The final P(i−1) element may be a hysteresis factor, where prior estimates of the emotional state may be used (i.e. fused, compiled) to determine a precise estimate or precise characteristic estimate as emotions typically take time to manifest and decay.

According to one example, for any given emotion, such as “anger”, the estimated strength of that emotion may be approximated using the following formula:

S(i)=w₀*t₀(t)*s₀+ . . . wᵢ*tᵢ(t)*sᵢ+ . . . wₛ*S(i−1)

Next, using the generated reports and the lexical representation, an overall semantics evaluation may be built or generated 220. That is, the system generates a recommendation as to the sentiment and affect of the words in the conversant input. This semantic evaluation may then compared and integrated with other data sources, specifically the biometric mood assessment data. 222.

According to one aspect, characteristics of an individual may be learned for later usage. That is, as the characteristics of an individual are gathered, analyzed and compiled, a profile of the individual's behavioral traits may be created and stored in the handset and/or on the server for later retrieval and reference. The profile may be utilized in any subsequent encounters with the individual. Additionally, the individual's profile may be continually refined or calibrated each time audio, visual and/or textual input associated with the individual is collected and evaluated. For example, if the individual does not have a tendency to smile even when providing positive information, when assigning weighted descriptive values to additional or subsequently gathered characteristics for that individual, these known behavioral traits of the individual may be taken into consideration. In other words, the system may be able to more accurately recognize emotions of that specific individual by taking into consideration the individual's known and document behavioral traits.

According to one aspect, in addition to profiles for a specific individual, general profiles of individuals may be generated. As audio, visual and/or textual input of each additional individual is collected and evaluated, this information may be utilized to further develop multiple different profiles. For example, the system may store profiles based on culture, gender, race and age. These profiles may be taken into consideration when assigning weighted descriptive values to subsequent individuals. The more characteristics that are obtained and added to the profiles, the higher the probability that the collected and evaluated characteristics of an individual are going to be accurate.

### Biometric (or Somatic) Mood Assessment

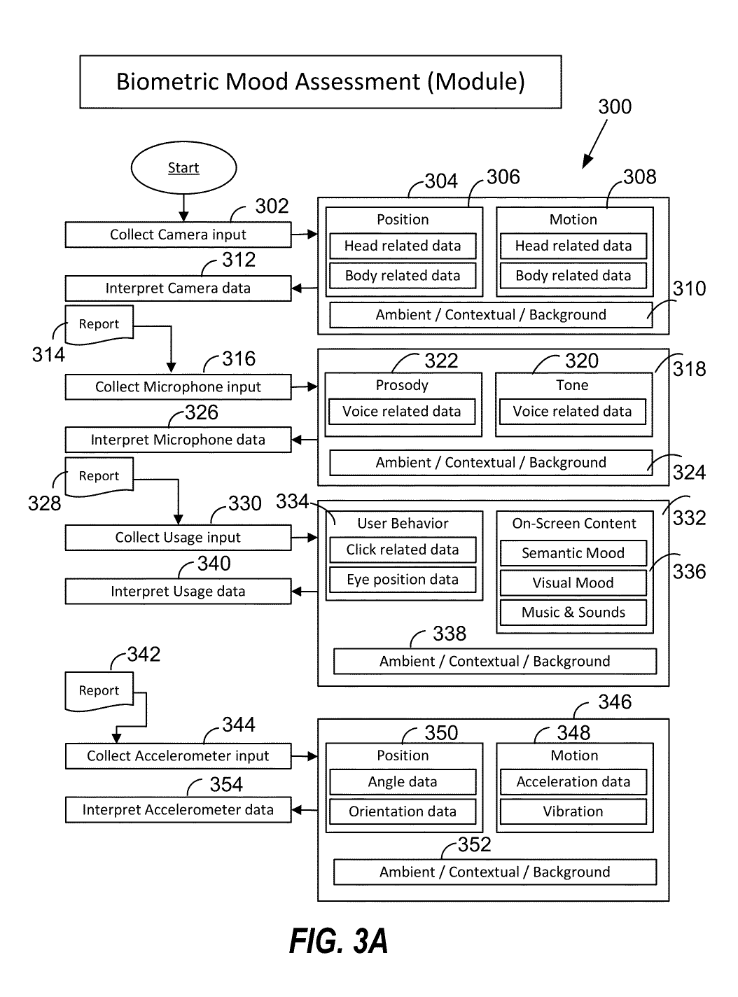

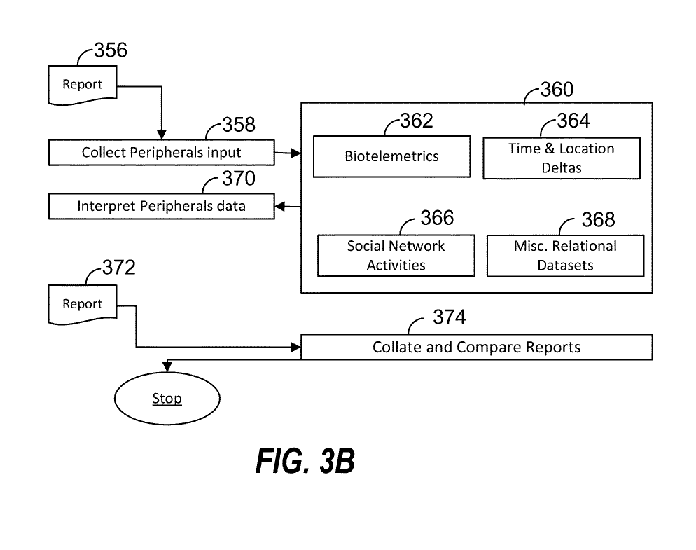

FIGS. 3A and 3B is a flow chart illustrating of a method of assessing the biometric mood in the form one or more potential imprecise characteristics of an individual, in accordance with an aspect of the present disclosure. As described herein, the terms “biometric” and “somatic” may be used interchangeably.

According to one example, a camera may be utilized to collect one or more potential imprecise characteristics in the form of biometric data 302. That is, a camera may be utilized to measure or collect biometric data of an individual. The collected biometric data may be potential imprecise characteristics descriptive of the individual. The camera, or the system (or device) containing the camera, may be programmed to capture a set number of images, or a specific length of video recording, of the individual. Alternatively, the number of images, or the length of video, may be determined dynamically on the fly. That is, images and/or video of the individual may be continuously captured until a sufficient amount of biometric data to assess the body language of the individual is obtained.

A camera-based biometric data module 304 may generate biometric data from the images and/or video obtained from the camera. For example, a position module 306 within the biometric data module 304 may analyze the images and/or video to determine head related data and body related data based on the position of the head and the body of the individual in front of the camera which may then be evaluated for potential imprecise characteristics. A motion module 308 within the biometric data module 304 may analyze the images and/or video to determine head related data and body related data based on the motion of the head and the body of the individual in front of the camera. An ambient/contextual/background module 310 within the biometric data module 304 may analyze the surroundings of the individual in front of the camera to determine additional data (or potential imprecise characteristics) which may be utilized in combination with the other data to determine the biometric data of the individual in front of the camera. For example, a peaceful location as compared to a busy, stressful location will affect the analysis of the biometrics of the individual.

Next, the data obtained from the camera-based biometric data module 304 is interpreted 312 for potential imprecise characteristics and a report is generated 314. The measurements provide not only the position of the head but delta measurements determine the changes over time helping to assess the facial expression, detailed to the position of the eyes, eyebrows, mouth, scalp, ears, neck muscles, skin color, and other information associated with the visual data of the head. This means that smiling, frowning, facial expressions that indicate confusion, and data that falls out of normalized data sets that were previously gathered, such as loose skin, a rash, a burn, or other visual elements that are not normal for that individual, or group of individuals, can be identified as significant outliers and used as factors when determining potential imprecise characteristics.

This biometric data will in some cases provide a similar sentiment evaluation to the semantic data, however in some cases it will not. When it is similar an overall confidence score may be increased, i.e. weighted descriptive value as to the confidence of the characteristic. When it is not that confidence the score, or the weighted descriptive value as to the confidence of the characteristic, may be reduced. All the collected biometric data may be potential imprecise characteristics which may be combined or fused to obtain one or more precise characteristics.

According to one example, a microphone (located in a handset or other peripheral device) may be utilized to collect biometric data 316. A microphone-based biometric data module 318 may generate biometric data from the sound and/or audio obtained from the microphone. For example, a recording module 320 within the microphone-based biometric data module 318 may analyze the sounds and/or audio to determine voice related data and based on the tone of the voice of the individual near the microphone. A sound module 322 within the microphone-based biometric data module 318 may analyze the sound and/or audio to determine voice related data and sound related data based on the prosody, tone, and speed of the speech and the voice of the individual near the microphone. An ambient/contextual/background module 324 within the microphone-based biometric data module 318 may analyze the surroundings of the individual near the microphone to determine additional data (or additional potential imprecise characteristics) which may be utilized in combination with the other data to determine the biometric data of the individual near the microphone, such as ambient noise and background noise. For example, a peaceful location as compared to a busy, stressful location will affect the analysis of the biometrics of the individual. Next, the data obtained from the microphone-based biometric data module 318 may be interpreted 326 and a report is generated 328.

According to one example, the use of the application or device, such as a touch-screen, may be utilized to collect biometric data 330. A usage-based biometric data module 332 may generate biometric data from the use of the application primarily via the touch-screen of the surface of the device. This usage input may be complemented with other data (or potential imprecise characteristics) relevant to use, collected from the camera, microphone or other input methods such as peripherals (as noted below). For example, a recording module 334 within the usage-based biometric data module 332 may analyze the taps and/or touches, when coordinated with the position of the eyes, as taken from the camera, to determine usage related data and based on the speed of the taps, clicking, or gaze of the individual using the device (e.g., this usage input may be complemented with data that tracks the position of the user's eyes via the camera such that the usage of the app and where the user looks when may be tracked for biometric results). A usage module 336 within the usage-based biometric data module 332 may analyze the input behavior and/or clicking and looking to determine use related data (i.e. potential imprecise characteristics) based on the input behavior, speed, and even the strength of individual taps or touches of a user, should a screen allow such force-capacitive touch feedback. An ambient/contextual/background module 338 within the usage-based biometric data module 332 may analyze the network activity of the user or individual to determine additional data which may be utilized in combination with the other data to determine the biometric data of the individual engaged in action with the network. For example, data such as an IP address associated with a location which is known to have previously been conducive to peaceful behavior may be interpreted as complementary or additional data of substance, provided it has no meaningful overlap or lack of association with normative data previously gathered.

Next, the data obtained from the usage-based biometric data module 332 may be interpreted 340 to obtain one or more potential imprecise characteristics and a report is generated 342.

According to one example, an accelerometer may be utilized to collect biometric data 344. An accelerometer-based biometric data module 346 may generate biometric data from the motion of the application or device, such as a tablet or other computing device. For example, a motion module 348 within the accelerometer-based biometric data module 346 may analyze the movement and the rate of the movement of the device over time to determine accelerometer related data (i.e. potential imprecise characteristics) based on the shakes, jiggles, angle or other information that the physical device provides. An accelerometer module 336 within the usage-based biometric data module 332 may analyze the input behavior and/or concurrent movement to determine use related data based on the input behavior, speed, and even the strength of these user- and action-based signals.

According to one example, a peripheral may be utilized to collect biometric data 358. A peripheral data module 360 may generate peripheral data related to contextual data associated with the application or device, such as a tablet or other computing device. For example, a time and location module 364 may analyze the location, time and date of the device over time to determine if the device is in the same place as a previous time notation taken during a different session. A biotelemetrics module 362 within the peripheral data module 360 may analyze the heart rate, breathing, temperature, or other related factors to determine biotelemetrics (i.e. potential imprecise characteristics). A social network activities module 366 within the peripheral data module 360 may analyze social media activity, content viewed, and other network-based content to determine if media such as videos, music or other content, or related interactions with people, such as family and friends, or related interactions with commercial entities, such as recent purchases, may have affected the probable state of the user. A relational datasets module 368 within the peripheral data module 360 may analyze additional records or content that was intentionally or unintentionally submitted such as past health or financial records, bodies of text, images, sounds, and other data that may be categorized with the intent of building context around the probable state of the user. That is, a profile of each user may be generated and stored in the device or on a server which can be accessed and utilized when determining the potential imprecise characteristics and precise characteristics of the user.

Next, the data obtained from peripheral data module 360 (i.e. potential imprecise characteristics) may be interpreted 370 and a report is generated 372.

In the same manner as the semantic data was compared to a pre-existing dataset to determine the value of the data relative to the sentiment, mood, or affect that it indicates, the measurements of biometric data may take the same path. The final comparisons of the data values 372 specifically where redundant values coincide 374 provides the emotional state of the conversant.

The measurements of biometric data may also be assigned weighted descriptive values and a weighted time value as is described above in FIG. 2 with regard to assessing the semantic mood of an individual. Specifically, the probability of the biometric data accurately reflecting the individual may be approximated using the following formula:

P(i)=w₀*t₀(t)*c₀+ . . . wᵢ*tᵢ(t)*cᵢ+ . . . wₚ*P(i−1)

Furthermore, the estimated strength of the biometric data may be approximated using the following formula:

S(i)=w₀*t₀(t)*s₀+ . . . wᵢ*tᵢ(t)*sᵢ+ . . . wₛ*S(i−1)

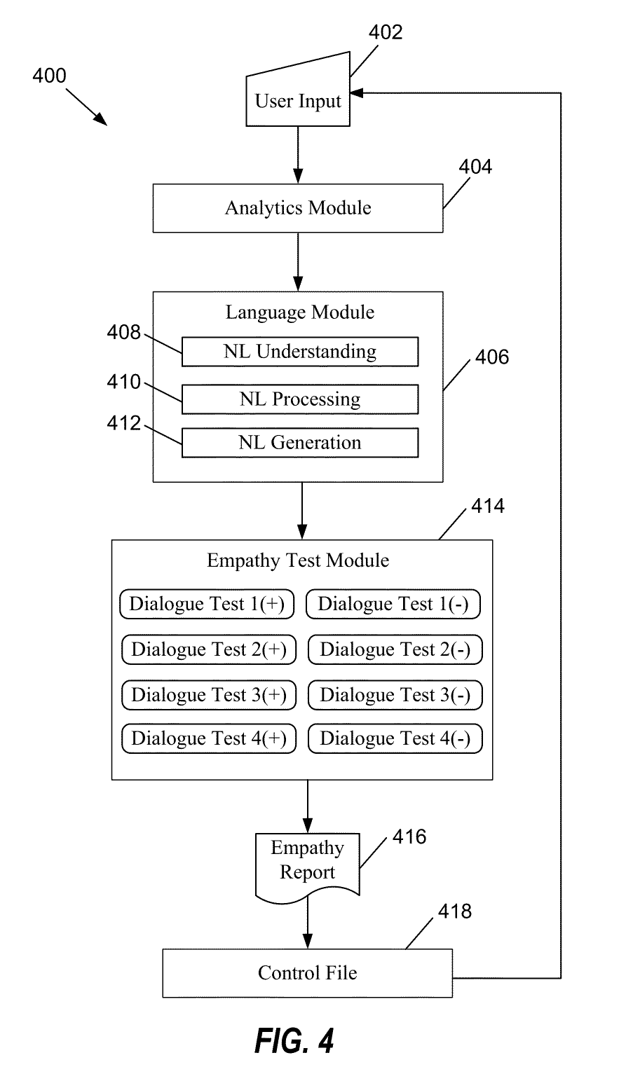

FIG. 4 is a flow chart 400 of a method of extracting semantic and biometric data from conversant input, in accordance with an aspect of the present disclosure. Semantic and biometric elements, or data, may be extracted from a dialogue between a software program and a user, or between two software programs, and these dialogue elements may be analyzed to orchestrate an interaction that achieves emotional goals set forth in the computer program prior to initiation of the dialogue.

In the method, first, user input 402 (i.e. conversant input or dialogue) may be input into an analytics module 404. The user input may be in the form of audio, visual or textual data generated via text, gesture, and/or spoken language provided by users. The analytics module 404 may determine the state of the user and the state of the system in addition to determining the relationship, or relative distances, between the user and the system. In other words, the analytics module 404 may determine elements which are utilized to generate the local path, as described in further detail below.

Next, output from the analytics module 404 may be input into a language module 406 for processing the user input. The language module 406 may include a natural language understanding module 408, a natural language processing module 410 and a natural language generation module 412.

The natural language module 408 may recognize the parts of speech in the dialogue to determine what words being used. Parts of speech can include, but is not limited to, verbs, nouns, adjectives, adverbs, pronouns, prepositions, conjunctions and interjections. Next, the natural language processing module 410 may generate data regarding what the relations are between the words and what the relations mean, such as the meaning and moods of the dialogue. Next, the natural language generation module 412 may generate what the responses to the conversant input might be.

The output of the language module 406 may then be input into an empathy test module 414 which may generate interaction reports 416 from a set of deltas run during the dialogue and are invisible to the interaction. The empathy test module 414 may comprise a plurality of deltas or test pairs. As shown in FIG. 4, each delta in the set of deltas 414 may be a dialogue test pair. For example, the set of deltas may include a first dialogue test pair (i.e. dialogue test 1(+) and dialogue test 1(−)), a second dialogue test pair (i.e. dialogue test 2(+) and dialogue test 2(−)), a third dialogue test pair (i.e. dialogue test 3(+) and dialogue test 3(−)), and a fourth dialogue test pair (i.e. dialogue test 4(+) and dialogue test 4(−)).

The empathy report 416 may be sent to a control file 418 which may drive the avatar animation and dynamically makes adjustments to the avatar. For example, each delta indicates a positive and negative score (or weighted descriptive value) helping guide the system and, by extension, the conversant, towards the goal. These deltas may be scored along a numeric scale and may be used to determine the words, actions, appearance, or sounds used by the software program and may also be used to control other later decisions or goals the system may contain. For example, the dialogue may cover a wide variety of topics and use a broad range of words, however there are several consistent elements of social interaction that are identified as indicating an interaction that is moving in a direction that generates mutual prediction and agreed-upon proximity, and therefor mutual trust. If the generated report indicates the proper signals that correspond with the signs of interaction the path may be continued but if the report does not show an appropriately high ranking of mutual sentiment then a new path may be chosen that more effectively achieves the predefined goal. Compared to conversations that do not reflect nor deflect the emotion of the user, enabling a program to dynamically generate these effects increases the apparent intelligence, instruction, and narrative abilities in computer-controlled dialogue.

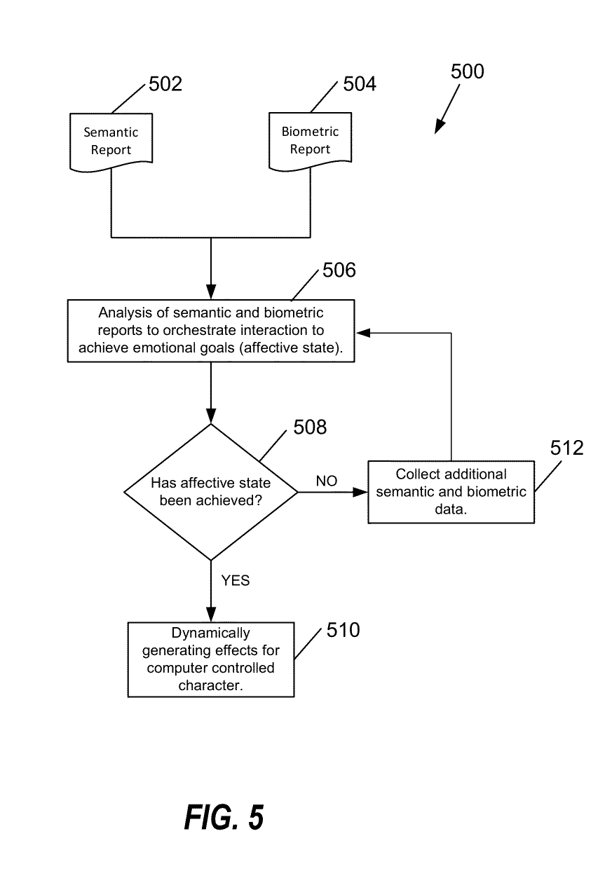

FIG. 5 is a flow chart 500 illustrating of an overview of achieving defined emotional goals or an affective state between a software program and a user, or between two software programs, according to one example. First semantic and biometric reports 502, 504 may be generated from a set of deltas (or dialogue test pairs) obtained from the conversant input or dialogue, as described above with reference to FIGS. 2-3, and are invisible to the interaction. The reports 502, 504 may then be analyzed to orchestrate an interaction that achieves the emotional goals set, or affective state, set forth in the computer program prior to initiation of the conversant input or dialogue 506. Next, a determination may be made if an affective state has been achieved 508. If an affective state has not been achieved, the reports do not show an appropriately high ranking of mutual sentiment. As such, additional semantic and biometric data may be collected 512 and the reports 502, 504 are again analyzed to orchestrate an interaction that achieves the emotional goals set, or affective state, forth in the computer program prior to initiation of the conversant input or dialogue 506. This process may be repeated until an affective state has been achieved.

If an affective state has been achieved, the system may dynamically generate effects for computer controlled characters or avatars 510. An affective state has been achieved if the reports 502, 504 indicate the proper signals correspond with the signs of interaction. Compared to conversations that do not reflect nor deflect the emotion of the user, the present disclosure enables a program to dynamically generate these effects which increase the apparent intelligence, instruction, and narrative abilities in computer-controlled dialogue.

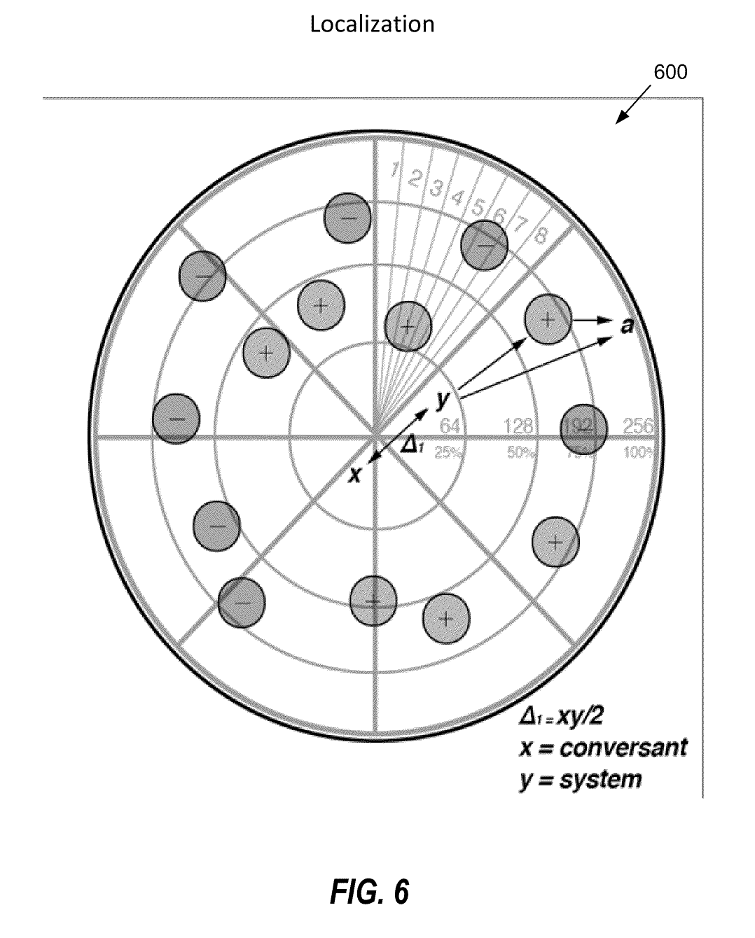

FIG. 6 illustrates a graph 600 utilized to determine a system's position relative to a conversant. The system (defined as “x”) may construct, or work from a pre-constructed, coordinate representation of its environment. According to one example, this coordinate representation may be, but is not limited to, a circle having 256 concentric circles and eight primary slices, each subdivided into 8 sub-slices providing 16,384 available coordinates. Although the geometric representation of the graph is illustrated as a circle, this is by way of example only. The geometric representation of the graph may also be a sphere, divided in latitude and longitude, or it may be other shapes, such as a cigar, cloud, or other multi-dimensional representations provided that it contains sub-divisible coordinates.

The system may then use this geometric data to begin to determine its current location or distance to the user. Unless otherwise pre-determined as a unique step in the path planning or path execution phases, and for the sake of this example, the system may begin at the center of the coordinate representation. Once the geometric data has been determined, the system may then be prepared for empathic feedback, or interaction with the conversant.

### Method for Determining Position Relative to Conversant

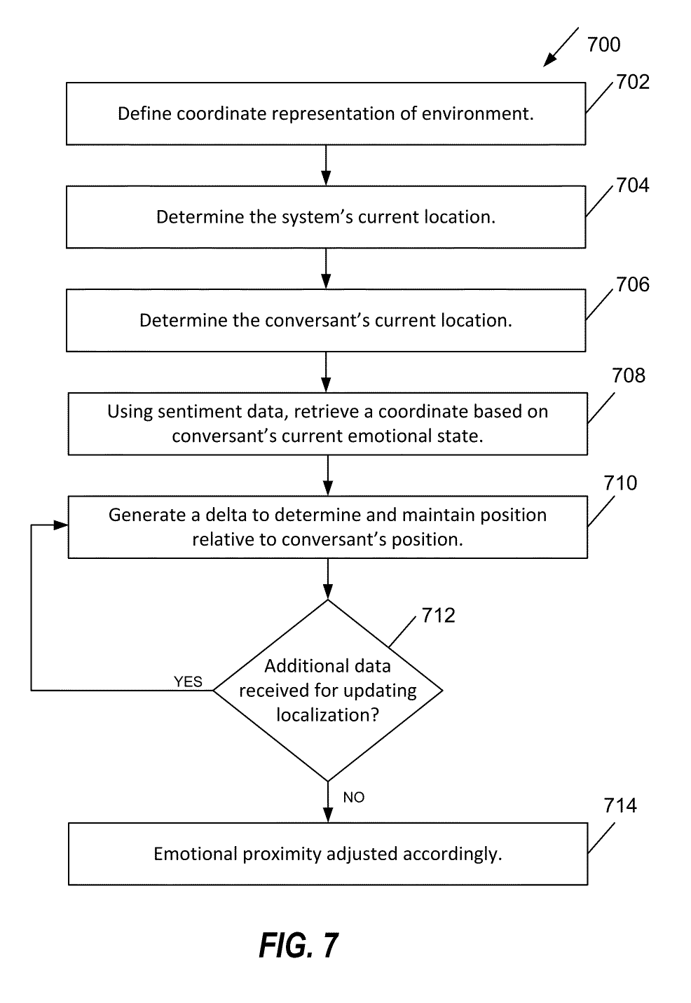

FIG. 7 illustrates a method 700 utilized by a system to determine its position (or distance) relative to the conversant. First, the system may define the coordinate representation of its environment 702 and then determine its current location 704. Next, the system may determine the conversant's current location 706.

Using sentiment data which may include biometric, semantic, or other data collected from peripheral devices, the system may then retrieve a coordinate that is based on the conversant's current emotional state (defined as “y”) 708. The system determines and maintains its emotional proximity (i.e. distance) relative to the conversant. This distance (or the changing distance between “x” and “y”) may be defined as “Δ¹”. That is, distance, Δ¹, may be determined from the distance from the system's local coordinate position and the conversant's calculated coordinate position at the start of the interaction. Δ¹ is the relative emotional proximity of the system and the user which frequently changes and which is a dominant factor in subsequent interaction. System response will be inversely proportional to this delta change. As this delta increases system response will decrease, as described further below.

The system may then generate this distance, the first of two deltas (“Δ¹”) to determine and maintain its position relative to the conversant's position 710. The first delta may be summarized to determine the conversant's location based on probabilistic inference. Furthermore, the first delta may mark the conversant's coordinate position, where each delta corresponds to a location where it believes it could be based on available sentiment, mood, or emotional data. Each delta may be based on sentiment data collected via methods known in the art.

As the conversant continues to provide input (via multiple vectors) 712, the system may rule out possible locations and the number of deltas decreases. As such, its confidence ranking states may rapidly converge to a more consistent location and the system may achieve coordinate-space localization of the conversant's emotional state through probabilistic inference. This may be an ongoing process which updates and tracks the changes of the conversant's emotional state on a regular basis which may or may not be manually configured.

The system performs localization updates on a delta that may happen at, but is not limited to, regular intervals, at significant moments, or during conversational turn-taking rounds. As the interaction progresses this emotional state may change in degrees as words, sounds, images and other data create affective influence. Δ¹ may track where the system is relative to the conversant. This delta's change is inversely proportional to the system's responsiveness.

Emotional proximity is maintained at Δ¹ and may be manually edited based on the desired outcome 714. The initial value of Δ¹ may be used as a default measurement for subsequent interactions. Δ¹ may be predefined, manually or automatically, for less-engaging system where Δ¹, or the default measurement for subsequent interactions, may be the maximum possible coordinate distance. This may be used for a system that is emotionally un-engaging. Inversely, if this proximity is decreased the system's emotional value may more closely match the conversant's emotional value, creating a much closer semblance or mirroring of the conversant's emotional measurement. In some cases multiple conditional deltas may be employed such that particular circumstances create a change in this delta.

### Method for Determining if Affective State Achieved

Path Planning (Global)

When the system has localized its own position, localized the conversant's position, and confirmed emotional proximity delta(s), it may be supplied with a destination coordinate, sometimes called an emotional goal. The system needs a path to arrive at the goal. If no path is provided it may dynamically generate one. To arrive at the emotional goal it may utilize a path. This path is sometimes provided at the beginning of the conversation. This path may be composed of words, topics, or n-grams or other contiguous or non-contiguous elements of text or speech to be discussed, a means of discussing them, and symbols such as images, sounds and other assets to support these emotions. A dialogue management system is one example of a means of mapping this path. If this path is not provided then the system will plan the path dynamically. The system must navigate around multiple objects to successfully arrive at the destination coordinate.

Destination coordinates are the emotional goal of the interaction but there may be hindrances to arrive there such as topics that cause an emotional reaction of a negative sort or unintentional interpretations, or simply interactions that are not understood. These “Affective Objects” may be comprised of known/unknown, desirable/undesirable, and inferred objects.

The system maps, maintains, and revises the map of the terrain as a dimensional image. The terrain may be populated with the “Affective Objects,” defined as coordinate sets. Affective objects may include, but are not limited to, (1) system location which are the coordinates the represent the system's location; (2) conversant location which are the coordinates of the conversant's location; (3) and known affective objects which are coordinates that have been successfully traversed with this conversant.

Known objects may be attractors or detractors. According to one example, a known detractor object may be a coordinate space of affective values derived from an n-gram that would cause some previously-measured emotional response. More specifically, if the system had used a particular word that caused offense that emotional measurement of offense would occupy a coordinate space. That coordinate space is a known object labeled with some relative features, such as the word and subsequent affective value. Some words are offensive to some people, but which word and which person is a specific, per-conversant, data set. According to one example, there may be four (4) types of known affective objects.

### Known Affective Object Type 1

The first type of known affective object may be other-reflective which may be a means of establishing closeness and a strong attractor and therefore strongly encourages the system to repeat the interaction that generated it. It may be marked by semantic or biometric data that indicates a preference for the actions of the other. This may also be the known object that best decreases deltas of emotional distance.

According to one example, lovers may use other-reflective known affective objects. For example, lovers may sit close across a table and stare into one another's eyes and say “I like you.” This includes maximal regard for personal state.

According to another example, friends may use other-reflective known affective objects. For example, friends may repeat the same action, such as a high-five or say the same words. Indications can include, but are not limited to, “What do you like?” “Is this what you want?” etc. Or compliments such as “You did great.”

According to yet another example, groups may use other-reflective known affective objects. For example, groups may do this when they conduct behavior that is aligned, such as simultaneously clapping, or singing in a chorale.

### Known Affective Object Type 2

The second type of known affective object may be self-reflective which may be a means of establishing closeness and a mild attractor that generally indicates a desire to be known and therefore encourages the system to generate an interaction that may generate other-reflective behavior.

According to one example, friends may do this when they discuss their opinions in a positive light. “I like fishing.” According to another example, groups may do this when they affirm a common area of interest such as sitting together at a concert or cinema.

### Known Affective Object Type 3

The third type of known affective object may be self-deflective which may be a means of establishing distance and a mild detractor that indicates a desire to be unknown and discourages the system from repeating an interaction that will generate the same.

According to one example, groups may do this when they split into separate sub-groups over topics of conversation, such as politics, or individual opinions, or when they exhibit competitive behavior by splitting into teams.

According to another example, enemies do this when they begin disagreements saying, “I disagree”.

### Known Affective Object Type 4

The fourth type of known affective object may be other-deflective which may be a means of establishing distance and a strong detractor that strongly discourages the system from repeating an interaction that will generate the same.

According to one example, groups may do this when they isolate an individual and cause violence to that individual, or say insulting phrases that identify a difference between them and the outcast.

According to another example, enemies may do this when they use phrases such as “You're stupid”. According to yet another example, combatants may do this when they strike one another or cause intentional damage with no regard to personal state.

Additionally affective objects may include, but are not limited to: (5) unknown affective objects; (6) inferred affective objects; (7) attractors; (8) detractors; and (9) goal.

Unknown affective objects may be coordinates that have never been traversed with this conversant.

Inferred affective objects may be coordinates that have never been traversed with this conversant but which have demonstrated consistent affective coordinate spaces with either multiple conversants of multiple related topics. Multiple other conversants that may have responded in a like manner to the same object. An example of this, again using offensive words, might be a word that two or more people responded negatively towards, and which, therefor, may be inferred to be offensive. In the case of related topics with that conversant it may be that other topics, which are measured to show more than a majority similarity, may be avoided as an inferred result.

Attractors may be affective objects that amplify the system's ability to achieve its goal, generally by traversing Known Objects or avoidance of Unknown Objects. In the example of n-grams, these would be words that have a positive affective influence, or in the case of images, a picture, gesture, sound, or other data that would have a positive affective influence.

Detractors may be affective objects that decrease the system's ability to traverse known affective objects or objects that cause the system to arrive in unknown space while goal may be a unique object that represents the destination of the global plan.

Once the plan methods are established the system refers to an emotional goal, A, that is either automatically or manually defined. In the following examples it will be towards developing trust, in which mirroring of behavior, emotional cues, and other semantic and biometric signals are exchanged, but the opposite, or a range of other possibilities exist. Goal A may be the opposite, such as fear rather than trust, based on the measurements of the sentiment graph used above. The Goal is a coordinate, as also noted above.

Path Execution (Local)

During local path execution, the system modulates its path to the goal based on the relationship it is establishing with the conversant. The system may search for and utilize one of several interaction models that match the relationship. Some affective objects may have an influence on the global path that is determined and these detractors, attractors, and other elements may have assigned values that measure their overall influence on the path. These may be expressed in negative and positive values, or, alternatively, as integers. Once a global plan has been generated, the local planner translates this path into a velocity that is relative to the location of the conversant.

The system may moves towards the predetermined goal after calculating the shortest possible path the system measures this against the position relative to the conversant. The system may move towards the predetermined goal and the system makes comparative analysis over the determined time to see if the conversant is following based on Δ¹. If the conversant is not following then the system returns, as described previously.

Emotional proximity may determine the system's speed towards the goal (“a”). It doesn't get too far away from the conversant. The conversant position, x, may be calculated in parallel with the system's position, y, and the distance XY—generally equal to Δ¹—is maintained as a value with a minimum buffer of one-half its own distance. If the proximity is less than that (XY/2 or in some cases Δ¹/2) then the system will advance towards its goal, and if the proximity is greater than the system will stop or return to previous indicators to maintain its proximity, avoiding known, unknown and inferred detractors.

By sampling and then simulating potential trajectories within this space, each simulated trajectory is scored and is then based on its predicted outcome, employing the highest-scoring trajectory as a move command to the system, and repeating this process until the goal has been reached. Newton Method and other systems may be applied to determine the best possible local course. For example the total target function generates a 3D landscape where the Newton Direction can be used to find the best way along the slope. The Newton Method can be evaluated in all points provided by the total target function. The total target function consist a target function and all penalty functions and barrier functions. The Newton Method determines the first and second order derivatives and uses them to find the best direction.

These data types are steps that each incline toward a particular affective coordinate set and are delivered in a turn-taking method in which the system and conversant alternate with the output and input of respective data.

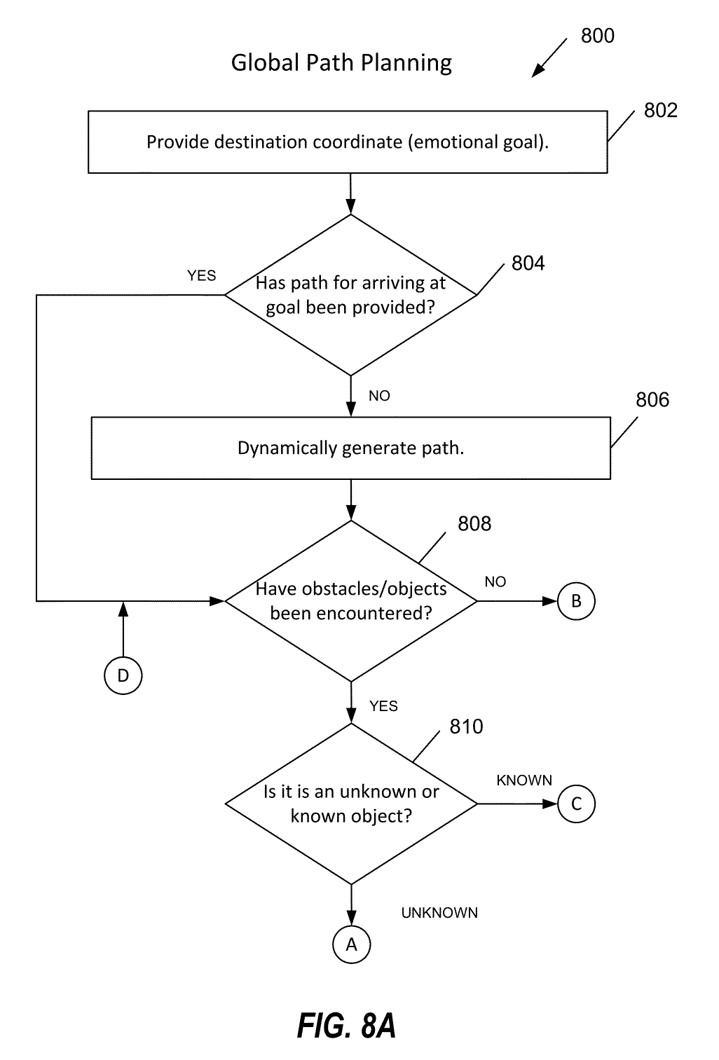

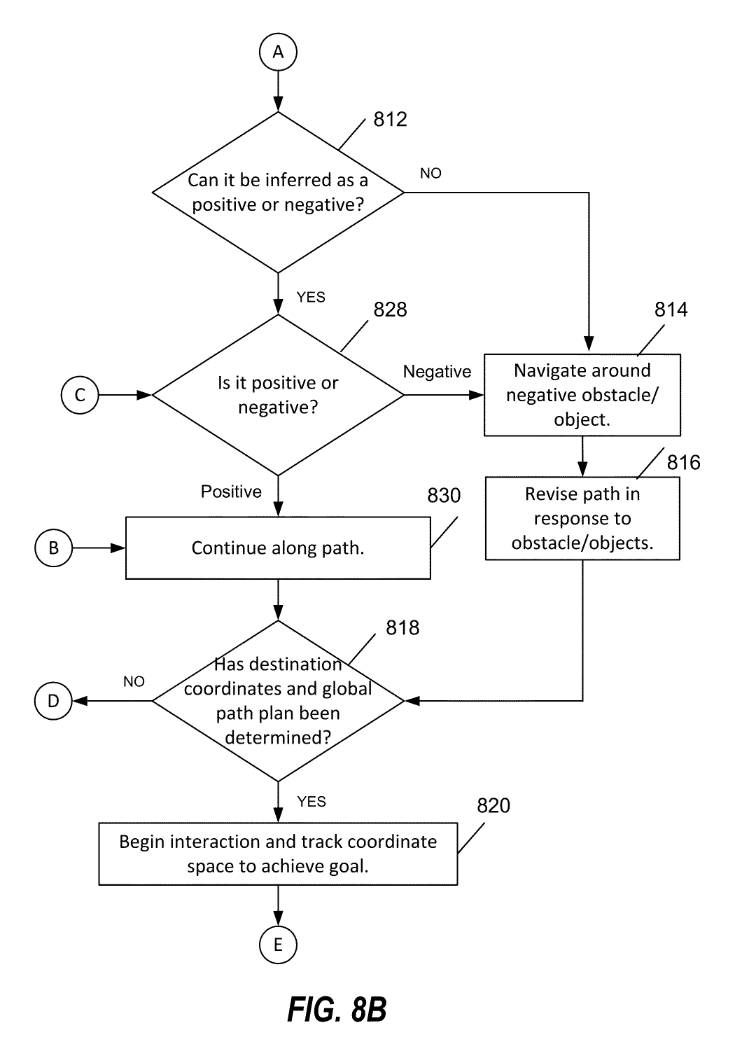

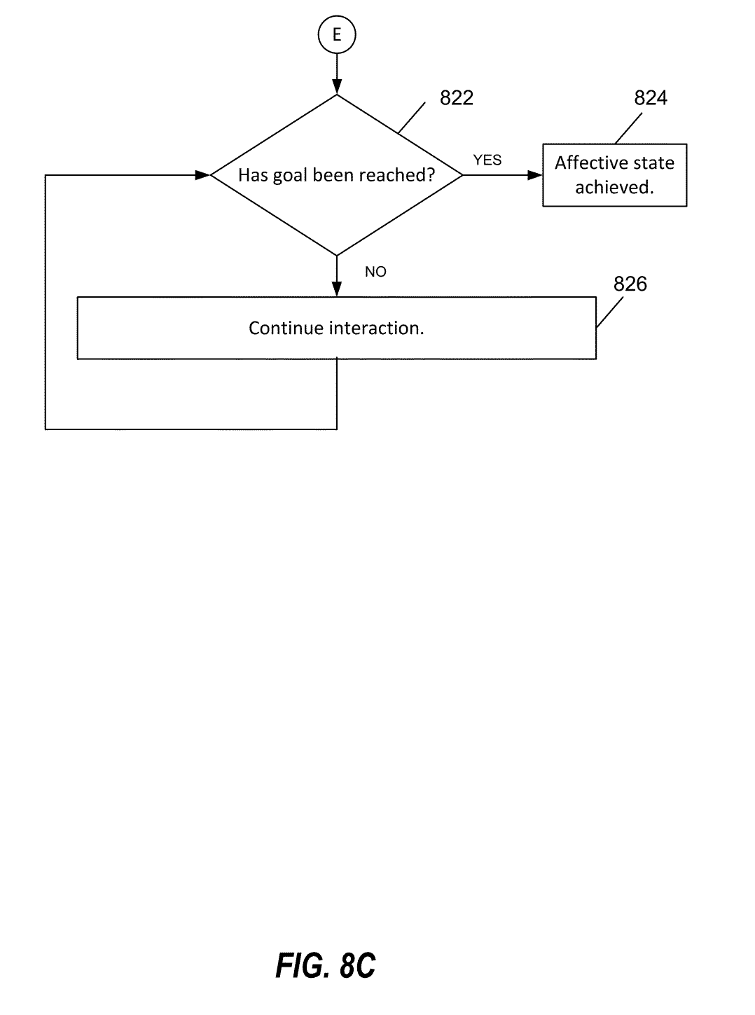

FIGS. 8A, 8B and 8C illustrate a method 800 utilized by a system to determine and achieve emotional goals set forth in the computer program prior to initiation of a dialogue. When the system has localized its own position, localized the conversant's position, and confirmed emotional proximity delta(s), as the system may be provided with a destination coordinate, sometimes called an emotional goal 802. To achieve and/or arrive at the emotional goal, the system may follow a path which may be provided to the system. The path may be provided at the beginning of the conversation and be comprised of words, topics, or n-grams or other contiguous or non-contiguous elements of text or speech to be discussed, a means of discussing them, and symbols such as images, sounds and other assets to support these emotions. One example of a means of mapping this path is a dialogue management system.

After the system has been provided the emotional goal, the system may first determine if a path to achieve this emotional goal has been provided 804. If the path has not been provided, the system may dynamically generate the path 806 during the dialogue. Once the system has a path to achieve the emotional goal, either pre-determined or dynamically generated, the system may proceed along the path. While proceeding along the path, the system may continually monitor for the path for any obstacles or objects 808.

### No Obstacles or Objects Encountered

If no obstacles or objects are encountered, the system may continue along the path to achieve the emotional goal and achieve affective state 830. Next, if the destination coordinates and global path plan of the system has been determined 818, the system may begin interaction and track coordinate space to achieve the emotional goal 820. That is, the system may begin the interaction and as it does so it keeps track of the coordinate space based on the above object types to best achieve its goal. This is a local path plan that is updated as the system progresses, inserting new detractors, attractors and other objects in the terrain as it navigates

If the emotional goal has been reached 822, affective state has achieved 824. Alternatively, if the emotional goal has not been reached 822, the system may continue the interaction 826 until the emotional goal has been reached and affective state has been achieved.

### Obstacles or Objects Encountered

If an obstacle or object is encountered, the system may navigate around the obstacles or objects to successfully arrive at the destination coordinate. Upon encountering an obstacle or object, the system may determine if the obstacle or object is known or unknown to the system 810.

Obstacles or Objects Unknown

If the obstacle or object is unknown, the system may determine if the obstacle or object can be inferred as a positive or a negative 812.

No Inference can be Made

If an inference cannot be made, the system may navigate around the obstacle or object 814 and revise its path in response to the obstacle or object 816. Once the path to achieve the emotional goal has been revised, the system may determine if its destination coordinates and global path plan have been determined 818.

Destination Coordinates and Global Path Plan Determined

If the destination coordinates and global path plan of the system has been determined 818, the system may begin interaction and track coordinate space to achieve the emotional goal 820. That is, the system may begin the interaction and as it does so it keeps track of the coordinate space based on the above object types to best achieve its goal. This is a local path plan that is updated as the system progresses, inserting new detractors, attractors and other objects in the terrain as it navigates

If the emotional goal has been reached 822, affective state has achieved 824. Alternatively, if the emotional goal has not been reached 822, the system may continue the interaction 826 until the emotional goal has been reached and affective state has been achieved.

Destination Coordinates and Global Path Plan not Determined

If the destination coordinates and global path plan of the system has not been determined 818, the system may continually determine if any obstacles or objects are encountered along the path 808 and repeat the process described above.

Inference can be Made

If the obstacle or object is unknown and the system can infer that obstacle or object is positive or a negative 812, the system may determine if the obstacle or object is positive or a negative 828.

Obstacles or Objects Inferred Negative

If the obstacle or object is unknown but can be inferred as negative, the system may navigate around the obstacle or object 814 and revise its path in response to the obstacle or object 816. Once the path to achieve the emotional goal has been revised, the system may determine if its destination coordinates and global path have been determined 818.

Obstacles or Objects Inferred Positive

If the unknown obstacles or objects can be inferred as positive, the system may continue along the path to achieve the emotional goal and achieve affective state 830. Next, if the destination coordinates and global path plan of the system has been determined 818, the system may begin interaction and track coordinate space to achieve the emotional goal 820. That is, the system may begin the interaction and as it does so it keeps track of the coordinate space based on the above object types to best achieve its goal. This is a local path plan that is updated as the system progresses, inserting new detractors, attractors and other objects in the terrain as it navigates

If the emotional goal has been reached 822, affective state has achieved 824. Alternatively, if the emotional goal has not been reached 822, the system may continue the interaction 826 until the emotional goal has been reached and affective state has been achieved.

Obstacles or Objects Known

If the obstacle or object is known, the system may determine if the obstacle or object is positive or a negative 828.

Obstacles or Objects Negative

If the obstacle or object is known and is negative, the system may navigate around the obstacle or object 814 and revise its path in response to the obstacle or object 816. Once the path to achieve the emotional goal has been revised, the system may determine if its destination coordinates and global path have been determined 818.

Destination Coordinates and Global Path Plan Determined

If the destination coordinates and global path plan of the system has been determined 818, the system may begin interaction and track coordinate space to achieve the emotional goal 820. That is, the system may begin the interaction and as it does so it keeps track of the coordinate space based on the above object types to best achieve its goal. This is a local path plan that is updated as the system progresses, inserting new detractors, attractors and other objects in the terrain as it navigates

If the emotional goal has been reached 822, affective state has achieved 824. Alternatively, if the emotional goal has not been reached 822, the system may continue the interaction 826 until the emotional goal has been reached and affective state has been achieved.

Destination Coordinates and Global Path Plan not Determined

If the destination coordinates and global path plan of the system has not been determined 818, the system may continually determine if any obstacles or objects are encountered along the path 808 and repeat the process described above.

Obstacles or Objects Positive

If the obstacle or object is known and is positive, the system may determine if its destination coordinates and global path have been determined 818.

Destination Coordinates and Global Path Plan Determined

If the destination coordinates and global path plan of the system has been determined 818, the system may begin interaction and track coordinate space to achieve the emotional goal 820. That is, the system may begin the interaction and as it does so it keeps track of the coordinate space based on the above object types to best achieve its goal. This is a local path plan that is updated as the system progresses, inserting new detractors, attractors and other objects in the terrain as it navigates

If the emotional goal has been reached 822, affective state has achieved 824. Alternatively, if the emotional goal has not been reached 822, the system may continue the interaction 826 until the emotional goal has been reached and affective state has been achieved.

Destination Coordinates and Global Path Plan not Determined

If the destination coordinates and global path plan of the system has not been determined 818, the system may continually determine if any obstacles or objects are encountered along the path 808 and repeat the process described above.

### Method for Assessing, Verifying and Adjusting Affective State of a User

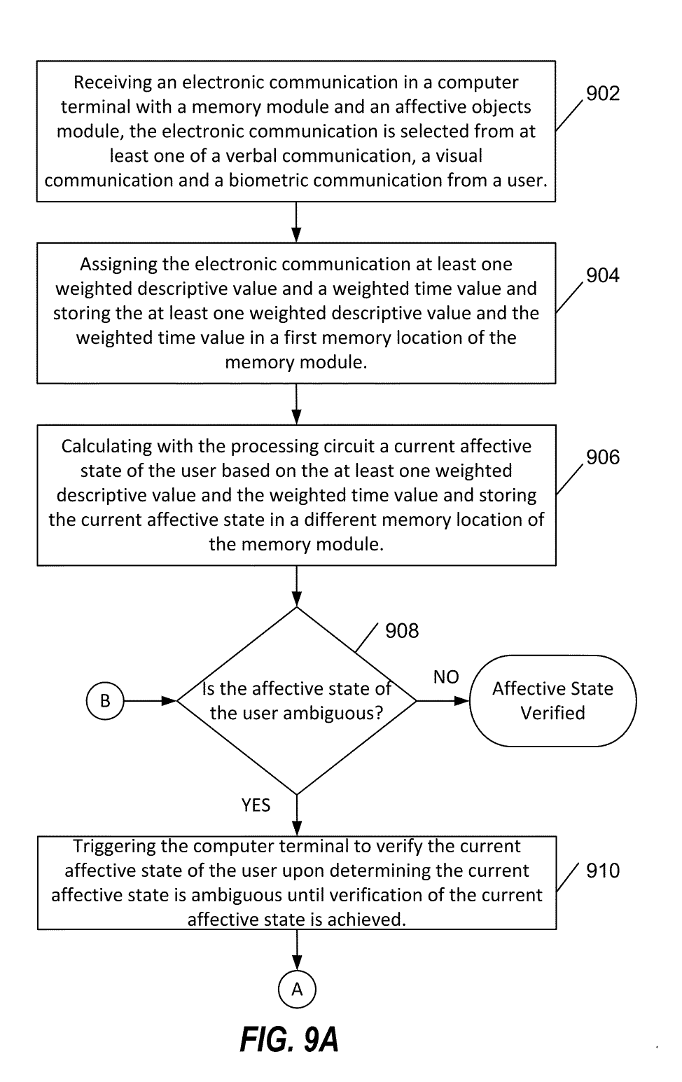

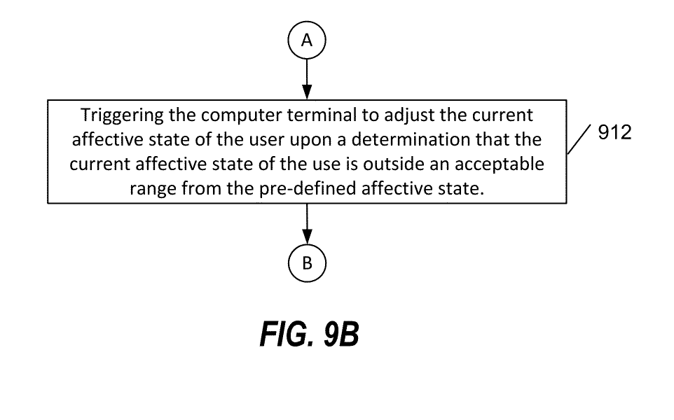

FIGS. 9A and 9B illustrate a method for assessing, verifying and adjusting the affective state of a user, according to one aspect. First, an electronic communication is received in a computer terminal having a processing circuit, a memory module and an affective objects module as described above. The electronic communication may be selected from at least one of a verbal communication, a visual communication and/or a biometric communication from a user 902. Next, the electronic communication may be assigned at least one first weighted descriptive value and a first weighted time value which are stored in the memory module in a first memory location 904. Using the at least one first weighted descriptive value and the first weighted time value the processing circuit of the computer terminal may calculate a current affective state of the user and store the current affective state in a second memory location of the memory module 906. The weighted descriptive values may be ranked as described above and the first memory location may be different than the second memory location.

Next, a determination may be made as to whether the current affective state of the user is ambiguous or unclear 908. The current affective state may be ambiguous or unclear if it is outside a pre-determined range of a pre-determined threshold affective state. For example, computer terminal may determine that there is a 30% chance the user is sad while there is a 70% chance the user is angry. Although two possible emotions are described, this is by way of example only and the computer terminal may narrow down the potential affective state of the user to more than two possibilities.

If a determination is made that the affective state is ambiguous, interactive techniques may be utilized to move the user toward a particular affective state. According to the example above, as it is more likely that the user is angry than sad, the interactive techniques may focus on verifying if the user is angry or sad. In other words, the computer terminal is triggered to interact with the user to verify the current affective state of the user until verification of the current affective state is achieved 910. Interactive techniques may include asking the user questions such as “Did I say something to upset you?” or “Did I do something wrong?”. Alternatively the computer terminal may interact by showing the user a video or picture and then analyze the user's reaction.

Once the affective state of the user has been verified, the computer terminal may be triggered to again interact with the user but this time to adjust the current affective state (or move the user toward the current affective state) upon a determination that the current affective state of the user is outside an acceptable range from a pre-defined affective state 912. The pre-defined affective state may be selected from an affective state database that may be dynamically built over time from prior interactions with previous users or prior interactions with the same user. The computer terminal may be triggered to interact with the user if the current affective state is outside the range of the threshold affective state. Interaction techniques may include, but are not limited to, telling a joke, showing a video, playing a cartoon, inviting the user to play a game, and showing an image. Any techniques that are known to adjust an affective state of a user may be utilized.

Once the affective state of the user has been verified and the user has been guided or moved within a range of the desired pre-determined threshold, the process is complete.

### Device

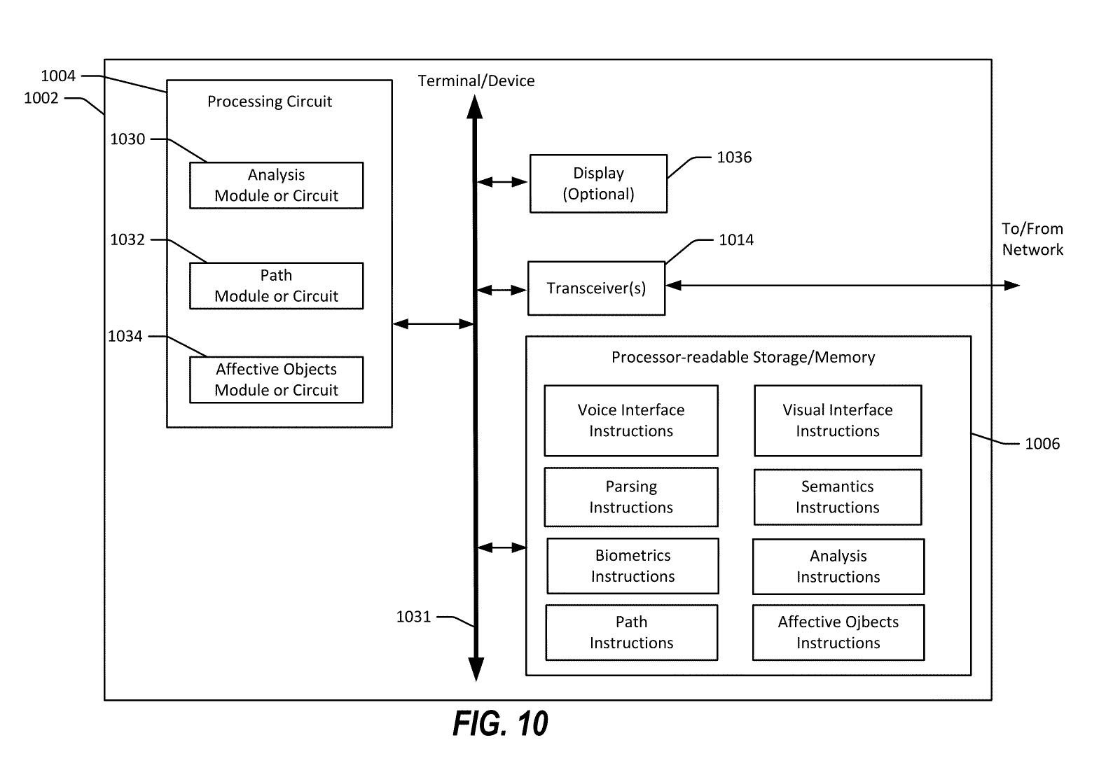

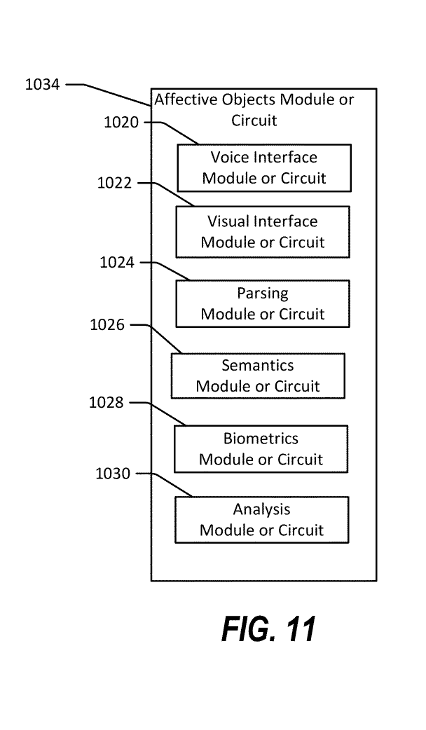

FIG. 10 is a diagram 1000 illustrating an example of a hardware implementation for a system 1002 configured to assess, verify and adjust the affective state of a user. FIG. 11 is a diagram illustrating an example of the modules/circuits or sub-modules/sub-circuits of the affective objects module or circuit of FIG. 10.

The system 1002 may include a processing circuit 1004. The processing circuit 1004 may be implemented with a bus architecture, represented generally by the bus 1031. The bus 1031 may include any number of interconnecting buses and bridges depending on the application and attributes of the processing circuit 904 and overall design constraints. The bus 1031 may link together various circuits including one or more processors and/or hardware modules, processing circuit 1004, and the processor-readable medium 1006. The bus 1031 may also link various other circuits such as timing sources, peripherals, and power management circuits, which are well known in the art, and therefore, will not be described any further.

The processing circuit 1004 may be coupled to one or more communications interfaces or transceivers 1014 which may be used for communications (receiving and transmitting data) with entities of a network.

The processing circuit 1004 may include one or more processors responsible for general processing, including the execution of software stored on the processor-readable medium 1006. For example, the processing circuit 1004 may include one or more processors deployed in the mobile computing device 102 of FIG. 1. The software, when executed by the one or more processors, cause the processing circuit 1004 to perform the various functions described supra for any particular terminal. The processor-readable medium 1006 may also be used for storing data that is manipulated by the processing circuit 1004 when executing software. The processing system further includes at least one of the modules or sub-modules 1020, 1022, 1024, 1026, 1028, 1030, 1032 and 1034. The modules 1020, 1022, 1024, 1026, 1028, 1030, 1032 and 1034 may be software modules running on the processing circuit 1004, resident/stored in the processor-readable medium 1006, one or more hardware modules coupled to the processing circuit 1004, or some combination thereof.

In one configuration, the mobile computer device 1002 for wireless communication includes a module or circuit 1020 configured to obtain verbal communications from an individual verbally interacting (e.g. providing human or natural language input or conversant input) to the mobile computing device 1002 and transcribing the natural language input into text, module or circuit 1022 configured to obtain visual (somatic or biometric) communications from an individual interacting (e.g. appearing in front of) a camera of the mobile computing device 1002, and a module or circuit 1024 configured to parse the text to derive meaning from the natural language input from the authenticated consumer. The processing system may also include a module or circuit 926 configured to obtain semantic information of the individual to the mobile computing device 1002, a module or circuit 1028 configured to obtain somatic or biometric information of the individual to the mobile computing device 1002, a module or circuit 1030 configured to analyze the semantic as well as somatic or biometric information of the individual to the mobile computing device 1002, a module or circuit 1032 configured to generate or follow a path of a dialogue, and a module or circuit 1034 configured to determine and/or analyze affective objects in the dialogue.

In one configuration, the mobile communication device 1002 may optionally include a display or touch screen 1036 for receiving and displaying data to the consumer.

### Semantic and Biometric Elements

Semantic and biometric elements may be extracted from a conversation between a software program and a user and these elements may be analyzed as a relational group of vectors to generate reports of emotional content, affect, and other qualities. These dialogue elements are derived from two sources.

First is semantic, which may be gathered from an analysis of natural language dialogue elements via natural language processing methods. This input method measures the words, topics, concepts, phrases, sentences, affect, sentiment, and other semantic qualities. Second is biometric, which may be gathered from an analysis of body language expressions via various means including cameras, accelerometers, touch-sensitive screens, microphones, and other peripheral sensors. This input method measures the gestures, postures, facial expressions, tones of voice, and other biometric qualities. Reports may then be generated that compare these data vectors such that correlations and redundant data give increased probability to a final summary report. For example, the semantic reports from the current state of the conversation may indicate the user as being happy because the phrase “I am happy” is used, while biometric reports may indicate the user as being happy because their face has a smile, their voice pitch is up, their gestures are minimal, and their posture is relaxed. When the semantic and biometric reports are compared there is an increased probability of precision in the final summary report. Compared to only semantic analysis, or only biometric analysis, which generally show low precision in measurements, enabling a program to dynamically generate these effects increases the apparent emotional intelligence, sensitivity, and communicative abilities in computer-controlled dialogue.

One or more of the components, steps, and/or functions illustrated in the figures may be rearranged and/or combined into a single component, step, or function or embodied in several components, steps, or functions without affecting the operation of the communication device having channel-specific signal insertion. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

While certain exemplary embodiments have been described and shown in the accompanying drawings, it is to be understood that such embodiments are merely illustrative of and not restrictive on the broad application, and that this application is not be limited to the specific constructions and arrangements shown and described, since various other modifications may occur to those ordinarily skilled in the art.

1. A computer implemented method for assessing, verifying and adjusting an affective state of users, comprising executing on a processing circuit the steps of:
receiving an electronic communication in a computer terminal with a memory module and an affective objects module, the electronic communication is selected from at least one of a verbal communication, a visual communication and a biometric communication from a user;
assigning the electronic communication at least one first weighted descriptive value and a first weighted time value and storing the least one first weighted descriptive value and the first weighted time value in a first memory location of the memory module;
calculating with the processing circuit a current affective state of the user based on the at least one first weighted descriptive value and the first weighted time value and storing the current affective state in a second memory location of the memory module; and
triggering the computer terminal to interact with the user to adjust the current affective state of the user upon a determination that the current affective state of the user is outside an acceptable range from a pre-defined affective state.

2. The method of claim 1, wherein the affective objects module in the computer terminal comprises a parsing module, a biometrics module, a voice interface module and a visual interface module.

3. The method of claim 1, wherein an interaction with the user is selected from at least one of verbal interaction and a visual interaction.

4. The method of claim 1, further comprising executing on the processing circuit the steps of:
triggering the computer terminal to interact with the user to verify the current affective state of the user upon determining the current affective state is ambiguous until verification of the current affective state is achieved.

5. The method of claim 4, wherein the current affective state is an emotion; and wherein the current affective state of the user is ambiguous when the emotion is uncertain.

6. The method of claim 5, wherein the emotion can be selected from at least two possible emotions.

7. The method of claim 1, further comprising executing on the processing circuit the steps of:
receiving a second electronic communication in the computer terminal from the user;
assigning the second electronic communication at least one second weighted descriptive value and a second weighted time value and storing the least at one second weighted descriptive value and the second weighted time value in a third memory location of the memory module; and
calculating with the processing circuit an updated current affective state of the user based on the at least one second weighted descriptive value and the first weighted time value and storing the current affective state in a fourth memory location of the memory module.

8. The method of claim 7, further comprising executing on the processing circuit the steps of:
triggering the computer terminal to interact with the user to verify the updated current affective state of the user upon determining the updated current affective state is ambiguous until verification of the updated current affective state is achieved; and
triggering the computer terminal to interact with the user to adjust the updated current affective state of the user upon a determination that the updated current affective state of the user is outside the acceptable range from the pre-defined affective state.

9. The method of claim 7, further comprising executing on the processing circuit the steps of:
triggering a direct interaction with the user by an individual upon a determination by the processing circuit that the updated current affect state has remained ambiguous for a pre-determined length of time.

10. The method of claim 1, wherein the pre-defined affective state is selected from an affective state database; wherein the affective state database is dynamically built from prior interactions between the computer terminal and previous users; and wherein the affective state of the user is updated on a pre-determined periodic time schedule.

11. A mobile device for dynamically for assessing, verifying and adjusting an affective state of users, the mobile device comprising:
a processing circuit;
a communications interface communicatively coupled to the processing circuit for transmitting and receiving information;
an affective objects module communicatively coupled to the processing circuit; and
a memory module communicatively coupled to the processing circuit for storing information, wherein the processing circuit is configured to:
receive an electronic communication in the mobile device, the electronic communication is selected from at least one of a verbal communication, a visual communication and a biometric communication from a user;
assign the electronic communication at least one first weighted descriptive value and a first weighted time value and storing the least one first weighted descriptive value and the first weighted time value in a first memory location of the memory module;
calculate with the processing circuit a current affective state of the user based on the at least one first weighted descriptive value and the first weighted time value and storing the current affective state in a second memory location of the memory module; and
trigger the mobile device to interact with the user to adjust the current affective state of the user upon a determination that the current affective state of the user is outside an acceptable range from the pre-defined affective state.

12. The mobile device of claim 11, wherein the affective objects module in the mobile device comprises a parsing module, a biometrics module, a voice interface module and a visual interface module.

13. The mobile device of claim 11, wherein an interaction with the user is selected from at least one of verbal interaction and a visual interaction.

14. The mobile device of claim 11, wherein the processing circuit is further configured to:
trigger the mobile device to interact with the user to verify the current affective state of the user upon determining the current affective state is ambiguous until verification of the current affective state is achieved.

15. The mobile device of claim 11, wherein the current affective state is an emotion; wherein the current affective state of the user is ambiguous when the emotion is uncertain; and wherein device of claim 14, wherein the emotion can be selected from at least two possible emotions.

16. The mobile device of claim 11, wherein the processing circuit is further configured to:
receive a second electronic communication in the mobile device from the user;
assign the second electronic communication at least one second weighted descriptive value and a second weighted time value and storing the least at one second weighted descriptive value and the second weighted time value in a third memory location of the memory module; and
calculate with the processing circuit an updated current affective state of the user based on the at least one second weighted descriptive value and the first weighted time value and storing the current affective state in a fourth memory location of the memory module.

17. The mobile device of claim 16, wherein the processing circuit is further configured to:
trigger the mobile device to interact with the user to verify the updated current affective state of the user upon determining the updated current affective state is ambiguous until verification of the updated current affective state is achieved; and
trigger the computer terminal to interact with the user to adjust the updated current affective state of the user upon a determination that the updated current affective state of the user is outside the acceptable range from the pre-defined affective state.

18. The mobile device of claim 17, wherein the processing circuit is further configured to:
trigger a direct interaction with the user by an individual upon a determination by the processing circuit that the updated current affect state has remained ambiguous for a pre-determined length of time.

19. The mobile device of claim 11, wherein the pre-defined affective state is selected from an affective state database; and wherein the affective state database is dynamically built from prior interactions between the computer terminal and previous users.

20. The mobile device of claim 11, wherein the affective state of the user is updated on a pre-determined periodic time schedule.
